(19) United States
(12) Patent Application Publication
(10) Pub. No.: US 2012/0028660 A1
(43) Pub. Date: Feb. 2, 2012

(54) METHOD AND APPARATUS FOR NOTIFYING DEVICES OF NEW MESSAGES

(76) Inventors: Matthew STAFFORD, Austin, TX (US); Justin McNamara, Atlanta, GA (US); Jeffrey Mikan, Atlanta, GA (US); Qun Wei, Redmond, WA (US)

(21) Appl. No.: 12/845,565

(22) Filed: Jul. 28, 2010

(51) Int. Cl. H04W 4/12

(52) U.S. Cl. 455/466

(57) ABSTRACT

In one embodiment, the present disclosure is a method and apparatus for notifying devices of new messages. In one embodiment, a method for notifying a subscriber device of the presence of a new message includes receiving the new message containing message content, and sending a notification message to the subscriber device, the notification message including a unique identifier for the new message and at least a portion of the message content.

### FIELD OF THE DISCLOSURE

The present disclosure relates generally to network communications and relates more particularly to techniques for notifying communication devices of new messages.

In the mobile environment, messages are predominantly exchanged between devices in a network using either short message service (SMS) or multimedia messaging service (MMS). For both of these protocols, the mobile subscriber integrated services digital network number (MSISDN)-based addressing is tied to a single device, and the only persistent message store is maintained on this device.

This limitation becomes a problem in a multi-device environment (i.e., a regime in which user agents on multiple devices require access to the same stream of messages). One way to allow all user agents access to the message stream is to synchronize the multiple devices with a message store, as is common with electronic mail clients. For example, a user's desk top computer and smart phone may be synchronized to a common message store. However, if the messages are delivered only to the message store (without notifications to the devices), then the devices must repeatedly poll the message store for updates. This increases the latency and decreases the efficiency of the network.

### SUMMARY

In one embodiment, the present disclosure is a method and apparatus for notifying devices of new messages. In one embodiment, a method for notifying a subscriber device of the presence of a new message includes receiving the new message containing message content, and sending a notification message to the subscriber device, the notification message including a unique identifier for the new message and at least a portion of the message content.

### BRIEF DESCRIPTION OF THE DRAWINGS

The teaching of the present disclosure can be readily understood by considering the following detailed description in conjunction with the accompanying drawings, in which:

FIG. 1 is a block diagram illustrating an exemplary packet network, configured according to embodiments of the current disclosure;

FIG. 2 is a flow diagram illustrating one embodiment of a method for notifying devices of new messages;

FIG. 3 is a flow diagram illustrating one embodiment of a method for retrieving messages; and

FIG. 4 is a high level block diagram of the message notification method that is implemented using a general purpose computing device.

To facilitate understanding, identical reference numerals have been used, where possible, to designate identical elements that are common to the figures.

### DETAILED DESCRIPTION

In one embodiment, the present disclosure is a method and apparatus for notifying devices of new messages. Embodiments of the disclosure employ an efficient notify-pull mechanism that supports interaction with a message store. Embodiments of the disclosure use session initiation protocol (SIP) as the delivery mechanism for new message notifications, although other delivery mechanisms (including concatenated SMS or hypertext transfer protocol (HTTP)) can be used. The present disclosure thus leverages existing transport protocols as a delivery mechanism for new message notifications.

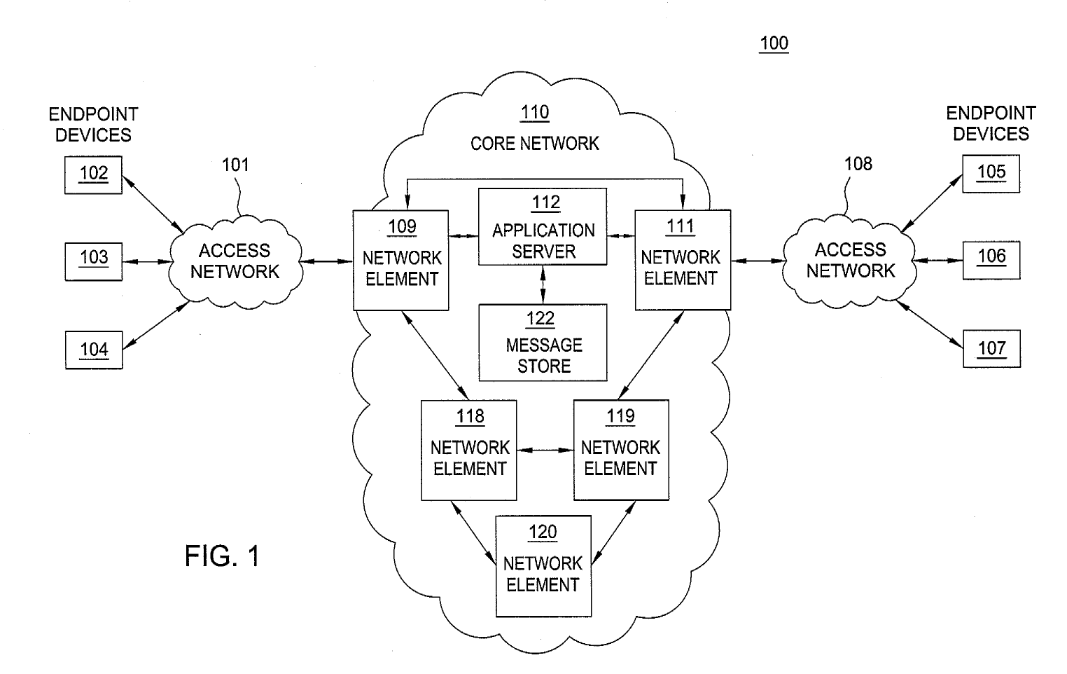

FIG. 1 is a block diagram illustrating an exemplary packet network 100, configured according to embodiments of the current disclosure. Exemplary packet networks include IP networks, Ethernet networks, IP multimedia subsystem (IMS) network, wireless networks, and the like. An IP network is broadly defined as a network that uses Internet Protocol such as IPv4 or IPv6, and the like, to exchange data packets. In one embodiment, the packet network 100 is a VoIP network.

In one embodiment, a first plurality of endpoint devices 102-104 reside outside the packet network and are configured for communication with the core packet network 110 (e.g., an IP-based core backbone network such as an IP multimedia subsystem (IMS) network) via a first access network 101. Similarly, a second plurality of endpoint devices 105-107 reside outside the packet network and are configured for communication with the core packet network 110 via a second access network 108.

The network elements (NEs) 109, 111, 118, 119, and 120 may serve as gateway servers or edge routers for the core packet network 110. In one embodiment, the first and second plurality of endpoint devices 102-104 and 105-107 comprise ISDN private branch exchanges (PBXs), automatic call distributors (ACDs), or ISDN telephones. In one embodiment, the first and second access networks 101 and 108 are time division multiplex (TDM) networks, and the like.

The endpoint devices 102-107 may also comprise subscriber endpoint devices such as personal computers, laptop computers, Personal Digital Assistants (PDAs), landline telephones, cellular telephones, gaming consoles, smart phones, electronic book readers, portable media players, servers, routers, and the like. In one embodiment, at least some of the endpoint devices 102-107 are ISDN telephones. The first and second access networks 101 and 108 serve as a means to establish a connection between the endpoint devices 102-107 and the NEs 109 and 111 of the core packet network 110. Thus, the endpoint devices 102-107 are outside of the access networks 101 and 108 and the core packet network 110. The first and second access networks 101 and 108 may each comprise a Digital Subscriber Line (DSL) network, a broadband cable access network, a Local Area Network (LAN), a Wireless Access Network (WAN), a third party network, a cellular network, and the like. The first and second access networks 101 and 108 may be either directly connected to NEs 109 and 111 of the core packet network 110, or indirectly through another network.

Some NEs (e.g., NEs 109 and 111) reside at the edge of the core packet network 110 and interface with subscriber endpoint devices 102-107 over various types of access networks (e.g., first and second access networks 101 and 108). An NE that resides at the edge of a core infrastructure is typically implemented as an edge router, a media gateway, a border element, a firewall, a switch, or the like. An NE may also reside within the network (e.g., NEs 118-120) and may be used as a mail server, a router, or a like device.

The core packet network 110 also comprises an application server 112 and a message store 122. The application server 112 supports one or more applications to which the endpoint devices 102-107 may subscribe, such as electronic mail, instant messaging, multimedia conferencing, and the like.

The message store 122 stores streams of messages generated in accordance with the applications hosted by the application server 112. It should be noted that in one embodiment, the message store 122 and the application server 112 can be optionally implemented as one consolidated system. In one embodiment, each message stored in the message store 122 is stored along with a unique identifier that allows the endpoint devices 102-107 to efficiently retrieve new messages. In one embodiment, these unique identifiers are Internet message access protocol (IMAP) 4 identifiers. In one embodiment, the message store 122 is an application server.

Those skilled in the art will realize that although only six endpoint devices 102-107, two access networks 101 and 108, and so on are depicted in FIG. 1, the packet network 100 may be expanded by including additional endpoint devices, access networks, border elements, and the like without altering the present disclosure.

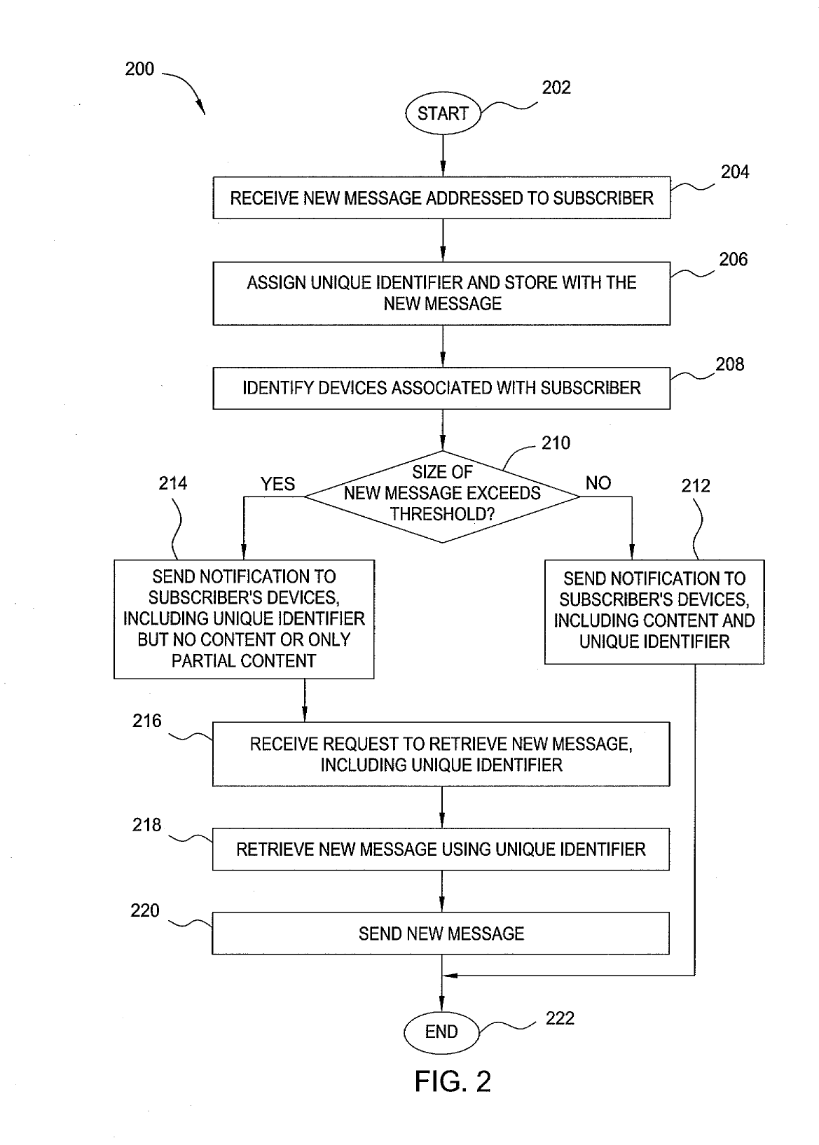

FIG. 2 is a flow diagram illustrating one embodiment of a method 200 for notifying devices of new messages. The method 200 may be implemented, for example, by the application server 112 and/or message store 122 illustrated in FIG. 1. As such, reference is made in the discussion of the method 200 to various elements of the packet network 100. It will be appreciated, however, that the method 200 is not limited to deployment in networks configured as illustrated in FIG. 1. The method 200 may, in fact, be deployed in networks that are configured in manners that differ from the configuration of the packet network 100.

The method 200 is initialized at step 202 and proceeds to step 204, where the message store 122 receives a new message addressed to a subscriber who has one or more endpoint devices 102-107 connected to the packet network 100. In step 206, the message store assigns a unique identifier to the new message. As discussed above, in one embodiment, the unique identifier is an IMAP4 identifier. The new message and the unique identifier are stored together in the message store 122.

In step 208, the message store 122 identifies the devices associated with the subscriber to whom the new message is addressed. These devices may include mobile and non-mobile devices. In one embodiment, the message store 122 knows whether or not a particular device is mobile.

The message store 122 then determines in step 210 whether the size of the new message exceeds a predefined threshold. For example, this predefined threshold defines the maximum message size (e.g., in terms of number of words, number of bytes, number of bits, and so on) that can be sent to the subscriber's devices. This threshold can be set by the transport protocol in use (for example, SIP over user datagram protocol (UDP) typically maxes out at 1300 bytes including headers). In one embodiment, however, the subscriber may define the threshold. In this case, the threshold may be lower than the maximum allowed by the transport protocol. Furthermore, the subscriber may define a number of different predefined thresholds, e.g., a first threshold of 10 words for personal messages from friends and family, whereas a second threshold of 25 words for all work related messages. These thresholds can be associated with the sending address or number of the individuals sending the messages. Furthermore, the subscriber may also alter these thresholds on the fly by sending a change to the subscriber preference profile, e.g., via a web based interface, i.e., a webpage maintained by the service provider.

If the message store 122 concludes in step 210 that the size of the new message does not exceed the predefined threshold, then the method 200 proceeds to step 212. In step 212, the message store 122 (or the application server 112 interacting with the message store 122) sends a notification message to the subscriber's devices. In this case, the notification message includes the content of the new message, plus a unique identifier that is contained within the body (content) of the notification message (e.g., as opposed to being contained in the header of the notification message). In one embodiment, the message store 122 may send the notification only to a sub-set of the subscriber's devices (e.g., only the mobile devices or only the non-mobile devices). The subscriber may configure his or her preferences such that notification messages are sent only to selected devices.

Alternatively, if the message store concludes in step 210 that the size of the new message does exceed the predefined threshold, the method 200 then proceeds to step 214. In step 214, the message store 122 (or the application server 112 interacting with the message store 122) sends a notification message to the subscriber's devices. In one this case, the notification message includes a unique identifier that is contained within the body (content) of the notification message (e.g., as opposed to being contained in the header of the notification message). However, the notification message does not contain the content of the new message, or contains only a limited portion of the content of the new message (e.g., as much as the predefined threshold will allow). If a limited portion of the content of the new message is contained in the notification message, the header of the notification message will indicate that the content is incomplete. As above, the message store 122 may send the notification only to a selected sub-set of the subscriber's devices.

After the notification message is sent (i.e., in accordance with step 214), the message store 122 receives a request to retrieve the new message from at least one of the subscriber's devices in step 216. In one embodiment, the request is received in response to a prompt displayed on the subscriber's device(s) (e.g., “Fetch message content? Y/N”). The request includes the unique identifier that was assigned to the new message in step 206. In step 218, the message store 122 retrieves the new message, using the unique identifier contained in the request. The message store 122 then sends the new message to the requesting device in step 220. The method 200 then terminates in step 222.

As discussed above, the body of the notification message may or may not include at least some of the content of the new message. The following sample message illustrates an exemplary case in which the body of the notification message transmits the unique identifier along with the content of the new message:

MESSAGE sip:+15123725623@ims.att.net SIP/2.0

.
.
.

Content-type: message/imdn+xml
Content-length: 174
NS: imdn <urn: ietf: params: imdn>
imdn.Message-ID: IMAP-UID-34jk324j
imdn.Disposition-Notification:
Content-type: text/plain
Content-length: 12
Hello World

In this case, everything up to the first blank line comprises SIP headers (note that that multipurpose Internet mail extension (MIME) for the SIP MESSAGE body is not text/plain). The five lines immediately following the first blank line comprise the instant message disposition notification (IMDN) header. The message body (i.e., “Hello World”) immediately follows the blank line after the IMDN header. Thus, the above example effectively comprises an envelope within an envelope. That is, the headers and body of the IMDN message are contained within the body of the SIP message.

The imdn.Message-ID line includes the literal “IMAP-UID-” to indicate that the string following the second dash (i.e., 34jk324j) is an IMAP message identifier (i.e., the new message's unique identifier). User agents that do not understand this will simply regard the entire message string as a message ID. This is important because some messages (e.g., intercarrier messages) may be addressed to devices that support the IMDN specification, but are not configured to execute the methods of the present disclosure. The above example also includes the imdn.Disposition-Notification header with an empty value, although this header can also be omitted altogether. As a further alternative, one or more non-null values (e.g., “positive-delivery” and/or “negative-delivery,” as defined by the Internet Engineering Task Force (IETF) Request for Comments (RFC) 5438) may be present in the imdn.Disposition-Notification header.

Because the new message content (body) is contained in the body of the notification message, there is no need for a receiving device to perform a fetch operation to retrieve the new message. In this case, the IMAP UID ensures that the receiving device will not end up with duplicate copies of the new message the next time the receiving device synchronizes with the message store 122. Without such a mechanism, it is much more difficult to manage duplicate messages.

As discussed above, the notification message may also omit the content of the new message. The following sample message illustrates an exemplary case in which the body of the notification message transmits the unique identifier without the content of the new message:

MESSAGE sip:+15123725623@ims.att.net SIP/2.0

.
.
.

Content-type: message/imdn+xml
Content-length: 119
NS: imdn <urn: ietf: params: imdn>
imdn.Message-ID: IMAP-UID-34jk324j
imdn.Disposition-Notification:

In this case, no message content (e.g., “Hello World”) is included. A receiving subscriber device will use the IMAP UID to fetch the message content. As discussed in connection with the method 200, this format for the notification message is appropriate when the new message is too large for inclusion in a SIP MESSAGE request (e.g., exceeds the predefined threshold). Compared to a full synchronization with the message store 122, significant efficiency is gained because the subscriber device can specify exactly which message it wants to fetch.

In yet another embodiment, the notification message may include some, but not all of, the content of the new message. For example, as discussed above, the notification message may include as much of the new message as is permitted by the constraints of the transport protocol or the subscriber defined threshold. The following sample message illustrates an exemplary case in which the body of the notification message transmits the unique identifier with only a portion of the content of the new message:

MESSAGE sip:+15123725623@ims.att.net SIP/2.0

.
.
.

Content-type: message/imdn+xml
Content-length: 179
NS: imdn <urn: ietf: params: imdn>
imdn.Message-ID: IMAP-UID-34jk324j
imdn.Disposition-Notification:
imdn.Content-Complete: no
Content-type: text/plain
Content-length: 17
Call me Ishmael.

Unlike the first two sample messages, the header of the third sample message includes an “imdn.Content-Complete” header that indicates whether the content of the new message that is contained in the notification message is complete.

All of the above exemplary notification message formats assume that a subscriber device that understands the Message-ID will also know how to access the message store 122. In the mobile environment, such operations are typically handled via over the air (OTA) provisioning. This improves efficiency, in that the necessary information is provisioned once and used many times (as opposed to repeatedly transmitting the information in each message exchange).

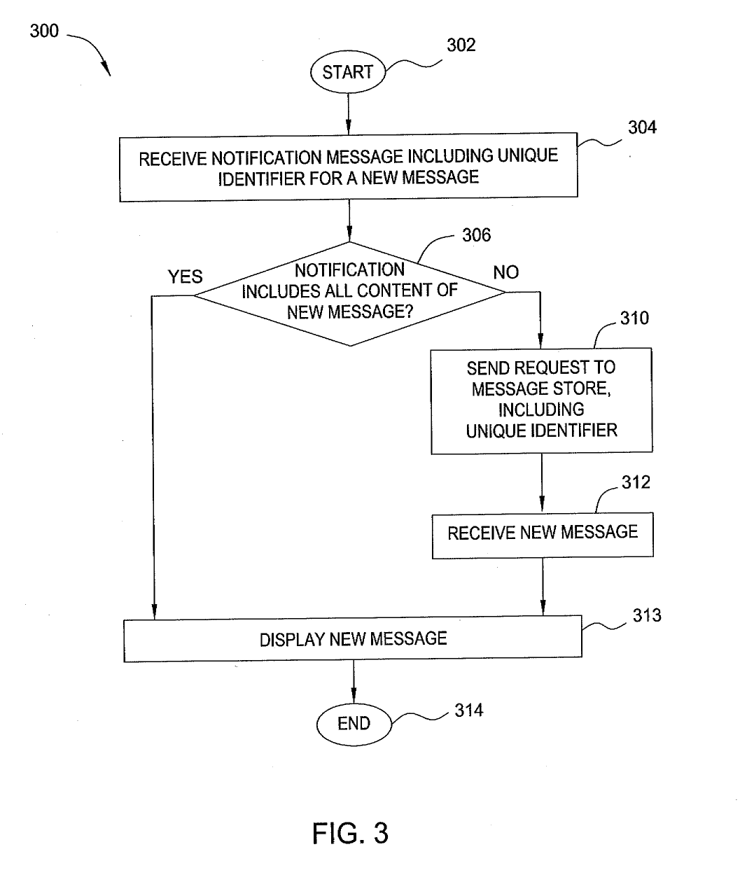

FIG. 3 is a flow diagram illustrating one embodiment of a method 300 for retrieving messages. The method 300 may be implemented, for example, by any of the subscriber endpoint devices 102-107 illustrated in FIG. 1. As such, reference is made in the discussion of the method 300 to various elements of the packet network 100. In particular, the endpoint device 102 is referenced for the purposes of discussion; the method 300 will operate in substantially the same manner at any of the other endpoint devices 103-107. It will be appreciated, however, that the method 300 is not limited to deployment in networks configured as illustrated in FIG. 1. The method 300 may, in fact, be deployed in networks that are configured in manners that differ from the configuration of the packet network 100.

The method 300 is initialized at step 302 and proceeds to step 304, where the endpoint device 102 receives a notification message from the message store 122 (or from the application server 112 interacting with the message store 122). The body of the notification message includes a unique identifier by which a new message for the endpoint device 102 is identified in the message store 122. As discussed above, in one embodiment, this identifier is an IMAP4 identifier.

In step 306, the endpoint device 102 determines whether the notification message includes all of the content of the new message. As discussed above, the body of the notification message may include all of the content of the new message or only a portion of the content of the new message. Alternatively, the body of the notification message may include only the unique identifier for the new message, but none of the content of the new message.

If the endpoint device 102 concludes in step 306 that the body of the notification message includes all of the content of the new message, then the endpoint device displays the content of the new message in step 313. The method 300 then terminates in step 314.

Alternatively, if the endpoint device 102 concludes in step 306 that the body of the notification message does not include all of the content of the new message (i.e., includes none of the content or includes only an incomplete portion of the content), then the endpoint device 102 sends a request to the message store 122 in step 310. The request requests a copy of the new message (e.g., at least the missing portions of the content of the new message) and includes the unique identifier that was provided in the notification message. In one embodiment, the request is sent only after the endpoint device 102 receives an affirmative reply from the subscriber in response to a prompt displayed on the endpoint device 102 (e.g., “Fetch message content? Y/N”).

In step 312, the endpoint device 102 receives the new message (e.g., at least the missing portions of the content of the new message) from the message store 122. The method 300 then proceeds to step 313 and proceeds as described above.

It should be noted that in one alternate embodiment, if a partial message content is included in the notification message, the method 300 may optionally display the partial message content immediately on the subscriber endpoint device before sending a request to the message store to retrieve the remaining portion of the entire message. This approach will allow the subscriber to immediately view a portion of the message before the entire message is retrieved. For example, the partial message content may comprise “This is John Doe, please call me immediately because . . . ” In this example, the subscriber may not know the reason for needing to call John Doe, but the subscriber will be immediately notified of the need to call John Doe. The subscriber may then optionally retrieve the full message before calling John Doe or the subscriber may simply call John Doe without retrieving the full message.

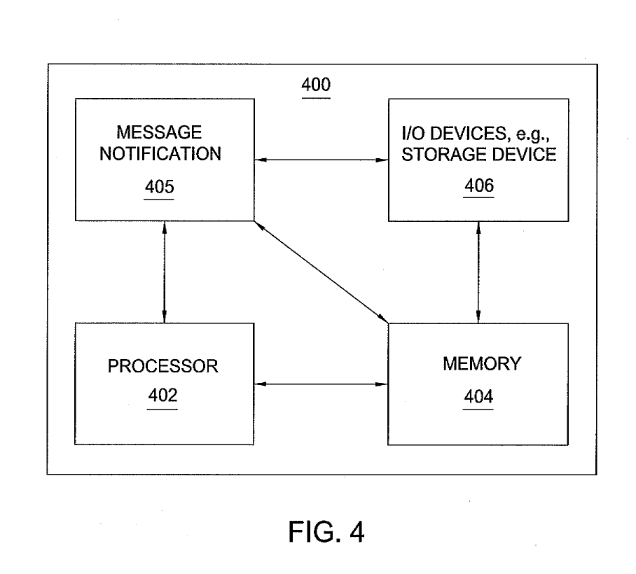

FIG. 4 is a high level block diagram of the message notification method that is implemented using a general purpose computing device 400. The general purpose computing device 400 may be part of a media gateway, for example. In one embodiment, a general purpose computing device 400 comprises a processor 402, a memory 404, a message notification module 405 and various input/output (I/O) devices 406 such as a display, a keyboard, a mouse, a modem, a stylus, a joystick, a keypad, controller, a network interface, and the like. In one embodiment, at least one I/O device is a storage device (e.g., a disk drive, an optical disk drive, a floppy disk drive). It should be understood that the message notification module 405 can be implemented as a physical device or subsystem that is coupled to a processor through a communication channel.

Alternatively, the message notification module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the message notification module 405 for notifying devices of new messages described herein with reference to the preceding Figures can be stored on a non-transitory computer readable storage medium (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for notifying a subscriber device of a presence of a new message, the method comprising:
receiving the new message containing message content; and
sending a notification message to the subscriber device, the notification message including a unique identifier for the new message and at least a portion of the message content.

2. The method of claim 1, wherein the notification is sent using a session initiation protocol.

3. The method of claim 1, wherein the notification message is sent using a concatenated short messaging service protocol.

4. The method of claim 1, wherein the notification message is sent using a hypertext transfer protocol.

5. The method of claim 1, wherein a size of the notification message, including the at least a portion of the message content, is less than or equal to a predefined threshold.

6. The method of claim 5, wherein the predefined threshold is subscriber-defined.

7. The method of claim 1, wherein a header of the notification message indicates that the at least a portion of the message content is incomplete when the at least a portion of the message content does not comprise all of the message content.

8. The method of claim 1, wherein the subscriber device comprises one of a select number of subscriber devices that is designated for receipt of notification messages.

9. The method of claim 8, wherein the number of subscriber devices is subscriber-defined.

10. The method of claim 1, further comprising:
storing the new message.

11. The method of claim 10, further comprising:
receiving a request for retrieval of the new message, the request including the unique identifier;
locating the new message using the unique identifier; and
sending the new message to a device from which the request was sent.

12. The method of claim 1, wherein the unique identifier is an Internet message access protocol 4 identifier.

13. The method of claim 1, wherein the notification message includes a header and a body, and the body of the notification message contains the unique identifier and the at least a portion of the message content.

14. A non-transitory computer readable medium containing an executable program notifying a subscriber device of a presence of a new message, where the program performs steps comprising:
receiving the new message, the new message including a header and a body, where the body contains message content; and
sending a notification message to the subscriber device, the notification message including a unique identifier for the new message and at least a portion of the message content.

15. The non-transitory computer readable medium of claim 14, wherein the notification is sent using a session initiation protocol.

16. The non-transitory computer readable medium of claim 14, wherein the steps further comprise:
storing the new message.

17. The non-transitory computer readable medium of claim 16, wherein the steps further comprise:
receiving a request for retrieval of the new message, the request including the unique identifier;
locating the new message using the unique identifier; and
sending the new message to a device from which the request was sent.

18. The non-transitory computer readable medium of claim 14, wherein the unique identifier is an Internet message access protocol 4 identifier.

19. The non-transitory computer readable medium of claim 14, wherein the notification message includes a header and a body, and the body of the notification message contains the unique identifier and the at least a portion of the message content.

20. A communication network, comprising:
an application server that supports at least one application through which one or more endpoints exchange a plurality of messages; and
a message store that stores the plurality of messages and sends a notification message to at least one of the plurality of endpoints when a new message is received, the notification message including a unique identifier for the new message and at least a portion of a message content contained in the new message.
